(19) United States
(12) Patent Application Publication
(10) Pub. No.: US 2016/0117457 A1
(43) Pub. Date: Apr. 28, 2016

(54) METHOD AND APPARATUS FOR ANALYZING PATIENT'S CONSTITUTIONAL PECULIARITY

(71) Applicant: SAMSUNG SDS CO., LTD., Seoul (KR)

(72) Inventors: Sung Il KIM, Seoul (KR); Myung Soo KIM, Yongin-si (KR)

(73) Assignee: SAMSUNG SDS CO., LTD., Seoul (KR)

(21) Appl. No.: 14/588,128

(22) Filed: Dec. 31, 2014

(30) Foreign Application Priority Data
Oct. 27, 2014 (KR) 10-2014-0146070

(51) Int. Cl. G06F 19/00; G06N 99/00; G06N 7/00

(52) U.S. Cl. CPC G06F 19/345; G06N 7/00; G06N 99/005

(57) ABSTRACT

A method of analyzing checkup data of a target object, using an apparatus including at least one processor, includes receiving checkup data of a target object associated with a first disease, the checkup data including checkup values for a plurality of onset factors of the first disease; determining whether the checkup data corresponds to a first disease statistic model obtained from checkup values of a plurality of objects associated with the first disease; and calculating, when the checkup data is determined not to correspond to the first disease statistic model as a result of the determination, a peculiarity value of the target object such that a sum of adjusted checkup values, the adjusted checkup values being obtained by adjusting checkup values for respective onset factors of the first disease of the target object based on the peculiarity value, is equal to a reference value.

### CROSS-REFERENCE TO RELATED APPLICATION

This application claims priority from Korean Patent Application No. 10-2014-0146070 filed on Oct. 27, 2014, in the Korean Intellectual Property Office, and all the benefits accruing therefrom under 35 U.S.C. 119, the contents of which in its entirety are herein incorporated by reference.

### TECHNICAL FIELD

The present invention relates to a method and an apparatus for analyzing a patient's constitutional peculiarity and more particularly, to a method and an apparatus that, when a specific examinee exhibits an examination result which is different from a statistical model reflecting data of a plurality of patients, provides a peculiarity value reflecting the constitutional peculiarity of the examinee.

### BACKGROUND

A disease prediction technology using a computing operation is provided. The disease prediction technology is mainly divided into gene analysis and environmental factor analysis. The gene analysis is expected to significantly influence the prediction and treatment of a human disease. Since the disease prediction technology by the gene analysis requires considerable cost and has a privacy protection issue, the disease prediction technology by the gene analysis is slowly being popularized.

The environmental factor analysis is a method which analyzes personal life, habits, and medical checkup values from a statistical point of view and deducts a significant result to introduce prediction of diseases and personalized prescription for the future. When big data analysis technology, which has been broadly utilized in recent years, is used, more data may be analyzed and as more data is analyzed, precision of the diseases prediction becomes higher.

However, when the environmental factor is analyzed, in order to generate a precise statistical model, it is important to secure more data from the population. Further, it is also important to identify a patient who does not fall within a general category, due to organic peculiarity while still providing a personalized medical service for the patient. This is because it is difficult to form a statistically significant community even though many populations of peculiar patients having organic peculiarity are secured.

Therefore, there is a demand for finding accurate data in respect to a constitutional peculiarity of the patient who does not fall within the general category to predict a disease or providing a personalized medical service to which the characteristic of the patient is reflected.

### SUMMARY

A technical object of embodiments of the present invention is to calculate a peculiar value reflecting a constitutional peculiarity of a patient who does not fall within a general category.

Another technical object of embodiments of the present invention is to predict a disease of the patient using the calculated peculiar value or to provide a personalized medical service specialized for the patient.

Still another technical object of the embodiments of the present invention is to accumulate checkup data or environmental factor data of the patient which does not fall within the general category in a population database to predict a disease for other patients whom do not fall within the general category later, based on a statistical model.

Technical objects of the present invention are not limited to the aforementioned technical objects and other technical objects which are not mentioned will be apparently appreciated by those skilled in the art from the following description.

According to the embodiment of the present invention, it is possible to provide a peculiar value obtained by digitizing a bio peculiarity of an examinee when a disease prediction result calculated by applying checkup data to a statistic model is different from an actual situation.

A personalized medical service for the examinee using the peculiar value may be provided.

A disease prediction service for the examinee using the peculiar value may be provided.

Checkup data of the examinee is added to a population database so that data of patients who are beyond a general scope is reflected in the statistic model and as a result it is possible to provide a disease prediction service based on a statistic model to the patients who are beyond a general scope with higher precision.

In some embodiments, A patient's constitutional peculiarity analyzing method comprises, receiving checkup data of an examinee having a first disease, determining whether the checkup data coincides with first disease statistic model obtained from checkup values of patients having the first disease, and calculating a peculiar value α of the examinee when the checkup data does not coincide with the first disease statistic model as a result of the determination result. The peculiar value of the examinee may be calculated such that a sum of adjusted checkup values for each onset factor of the first disease is equal to a reference value of patients, and the adjusted checkup value for a specific onset factor may be a value obtained by reflecting a personalized weight for the specific onset factor to the checkup value of the examinee with respect to the specific onset factor, and the personalized weight for the specific onset factor may be a value determined based on the peculiar value α of the examinee.

The reference value of patients may be an aggregate value of onset contribution ratio reflected checkup value medians (DF_MIDᵢ) for each onset factor Dfactorᵢ in accordance with the first statistic disease model, and the checkup value median DF_MIDᵢ may indicate a distance between a center of a representative cluster of Dfactorᵢ on a n dimensional space and the origin of the n dimensional space.

The reference value of patients may be an aggregate value of onset contribution ratio reflected checkup value medians (DF_MIDᵢ) for each onset factor Dfactorᵢ in accordance with the first statistic disease model, and the checkup value median DF_MIDᵢ may indicate an average value of a distances between points belonging to a representative cluster of Dfactorᵢ on a n dimensional space and the origin of the n dimensional space.

In some embodiments, the determining may comprise generating the first disease statistic model using the checkup data for each onset factor of the first disease of a patient having the first disease which is provided from a population database providing apparatus. And, the checkup value data may include checkup values for a plurality of sub onset factors included in each of the onset factors. The generating of a first disease statistic model may comprise a first step of mapping a point indicating a checkup value for the first disease onset factor of a patient of the population database, on the n (n is a number of sub onset factors) dimensional space using checkup values for a plurality of sub onset factors belonging to the first onset factor of the first disease, a second step of repeating the first step for checkup value data of other patients of the population database, a third step of obtaining a representative cluster for the first onset factor, by using of density based clustering, a fourth step of setting the representative cluster as a first disease statistic model for the first disease factor, and a fifth step of repeating the first to fourth step on second to M onset factors (M is the number of onset factors of the first disease) of the first disease. The third step may comprise, a step 3A of selecting one of the points which are mapped on the n dimensional space in the first step, a step 3B of determining whether a predetermined number p of points is present within a predetermined radius c from the point selected in the step 3A to determine whether the representative cluster with the selected point as a center is established, a step 3C of repeating the steps 3A and 3B on other entire points which are mapped on the n dimensional space in the first step, and a step 3D of, when the representative cluster is not established through the step 3A to step 3B, adjusting at least one of c and p, and then repeating the steps 3A and 3B. The step 3B may comprise determining that a plurality of representative clusters is established.

In some embodiments, the determining may further comprise, a step A of mapping an examinee point indicating a checkup value for the first onset factor of the examinee onto the n-dimensional space using the checkup values for a plurality of sub onset factors which is contained in the first onset factor of the checkup data of the examinee, a step B of determining whether the checkup value for the first onset factor of the examinee coincides with the first disease statistic model by determining whether the examinee point belongs to the representative cluster for the first onset factor to, and a step C of repeating the step A and the step B on the second to M onset factors. The determining whether the checkup value for the first onset factor of the examinee coincides with the first disease statistic model may comprise, assigning, when an examinee point indicating a checkup value of the examinee for the first onset factor belongs to the representative cluster for the first onset factor, a point determined based on an onset contribution ratio of the first onset factor, for a first onset factor, repeating the assigning of a point for the second to M onset factors, determining, when the added values of the assigned points for each onset factor exceed a reference value for the first disease, that the checkup data of the examinee coincides with the first disease statistic model. The determining may also comprise, calculating a distance between an examinee point indicating a checkup point of an examinee for a first onset factor and a center of a representative cluster for the first onset factor, adjusting the calculated distance by reflecting a weight determined based on an onset contribution ratio of the first onset factor, repeating the adjusting of a distance for the second to M onset factors, and determining, when the added values of the adjusted distances for each onset factor below a reference value for the first disease, that the checkup data of the examinee coincides with the first disease statistic model.

In some embodiments, the first disease statistic model maybe obtained from a checkup value for each onset factor of the first disease of a patient having the first disease provided from a population database providing apparatus. Further, the method may further comprise, updating the population database by inserting the checkup data of the examinee to the population database, receiving another checkup data of an examinee having the first disease, generating an updated first disease statistic model using the updated population database, and determining whether the another checkup data coincides with the updated first disease statistic model.

In some embodiments, the method may further comprise, determining whether the checkup data coincides with a second disease statistic model obtained from a checkup value of a patient having the second disease when the examinee has the second disease which is different from the first disease, and calculating, when it is determined that the checkup data does not coincide with the second disease statistic model, an updated peculiar value of the examinee, using only a part of the checkup values which coincide with the second disease statistic model among the checkup data of the examinee.

In some embodiments, the method may further comprise, predicting an onset possibility of a second disease which is different from the first disease, using the calculated peculiar value. The predicting may comprise, adjusting a part of the checkup values by reflecting the peculiar value to the part of checkup values as a weight, determining whether checkup data of the examinee containing the adjusted checkup values coincide with a second disease statistic model obtained from checkup values of patients having the second disease, predicting the onset possibility of the second disease based on the result of the determining whether checkup data of the examinee containing the adjusted checkup values coincide with the second disease statistic model.

In some embodiments, the method may further comprise, transmitting the calculated peculiar value to a personalized prescribing apparatus for adjusting of the prescription using the peculiar value.

In some embodiments, a patient's constitutional peculiarity analyzing method comprises receiving checkup data of an examinee having a first disease, determining whether the checkup data coincides with a first disease statistic model obtained from checkup values of patients having the first disease, and calculating a peculiar value α of the examinee when it is determined that the checkup data does not coincide with the first disease statistic model. The peculiar value of the examinee may be calculated such that a sum of adjusted checkup values for each onset factor of the first disease is equal to a reference value of patients, and the adjusted checkup value for a specific onset factor may be a value obtained by reflecting a personalized weight for the specific onset factor to the checkup value of the examinee with respect to the specific onset factor, and the adjusted checkup value for a specific onset factor maybe a value obtained by reflecting a personalized weight for the specific onset factor to the checkup value of the examinee with respect to the specific onset factor, and the personalized weight for the specific onset factor may be set to be a first weight based on a peculiar value α of the examinee when the checkup value of the examinee for the specific onset factor coincides with the first disease statistic model for the specific onset factor, and set to be a second weight based on the peculiar value α of the examinee when the checkup value of the examinee for the specific onset factor does not coincide with the first disease statistic model for the specific onset factor. The first weight is different from the second weight. The first weight may be a positive (+) value but the second weight is a negative (−) value. Both the first weight and the second weight may be positive (+) values and the first weight may be larger than the second weight.

In some embodiments a patient's constitutional peculiarity analyzing method comprises, receiving checkup data of an examinee having a first disease, determining whether the checkup data coincides with a first disease statistic model obtained from checkup values of patients having the first disease, calculating a peculiar value of the examinee using only a part of the checkup values which coincides with the first disease statistic model, among the checkup data, when the checkup data does not coincide with the first disease statistic model. The calculating of a peculiar value may comprise, calculating the peculiar value of the examinee so that a sum of adjusted checkup values for each onset factor which coincides with the first disease statistic model, is equal to a reference value of patients. The adjusted checkup values may be obtained by reflecting the peculiar value as a weight to the checkup values for each onset factor which coincides with the first disease statistic model. The calculating the peculiar value of the examinee so that a sum of adjusted checkup values for each onset factor which coincides with the first disease statistic model, is equal to a reference value of patients may further comprise, calculating the peculiar value of the examinee so that a sum of adjusted checkup values for each onset factor which coincides with the first disease statistic model, is equal to a reference value of patients. The adjusted checkup values may be obtained by reflecting both an onset contribution ratio for a checkup item of the checkup value as a first weight, and the peculiar value as a second weight. The reference value of patients may be a sum of values obtained by reflecting an onset contribution ratio of the onset factor to a checkup value median for each onset factor in accordance with the first disease statistic model.

In some embodiments a computer program product embodied on a non-transitory readable storage medium containing instructions that when executed by a processor cause a computer to receive checkup data of an examinee having a first disease, determine whether the checkup data coincides with first disease statistic model obtained from checkup values of patients having the first disease, and calculate a peculiar value α of the examinee when the checkup data does not coincide with the first disease statistic model as a result of the determination result. The peculiar value of the examinee may be calculated such that a sum of adjusted checkup values for each onset factor of the first disease is equal to a reference value of patients, and the adjusted checkup value for a specific onset factor is a value obtained by reflecting a personalized weight for the specific onset factor to the checkup value of the examinee with respect to the specific onset factor, and the personalized weight for the specific onset factor is a value determined based on the peculiar value α of the examinee.

In some embodiments a patient's constitutional peculiarity analyzing apparatus, comprises a network interface, a memory; and a storage device in which an execution file of a computer program which is loaded in the memory and executed by the processor is recorded. The computer program comprises, a series of instructions of receiving checkup data of an examinee having a first disease, a series of instructions of determining whether the checkup data coincides with first disease statistic model obtained from checkup values of patients having the first disease, and a series of calculating a peculiar value α of the examinee when the checkup data does not coincide with the first disease statistic model as a result of the determination result. The peculiar value of the examinee may be calculated such that a sum of adjusted checkup values for each onset factor of the first disease is equal to a reference value of patients, and the adjusted checkup value for a specific onset factor may be a value obtained by reflecting a personalized weight for the specific onset factor to the checkup value of the examinee with respect to the specific onset factor, and the personalized weight for the specific onset factor may be a value determined based on the peculiar value α of the examinee.

### BRIEF DESCRIPTION OF THE DRAWINGS

The above and other features and advantages of the present invention will become more apparent by describing in detail embodiments thereof with reference to the attached drawings in which:

FIG. 1 is a diagram of a patient's constitutional peculiarity analyzing system according to an embodiment of the present invention;

FIG. 2 is a diagram of a patient's constitutional peculiarity analyzing system according to another embodiment of the present invention;

FIG. 3 is a flowchart of a patient's constitutional peculiarity analyzing method according to another embodiment of the present invention;

FIG. 4 is a detailed flowchart of a part of operations of the embodiment of the present invention illustrated in FIG. 3;

FIGS. 5 and 6 are views explaining a process of generating a statistical model of a peculiar disease from data of a population database for a patient for the peculiar disease;

FIG. 7 is a detailed flowchart of another part of operations of the embodiment of the present invention illustrated in FIG. 3;

FIG. 8 is a view explaining a method of evaluating whether checkup data of an examinee having a peculiar disease coincides with a statistical model for the peculiar disease;

FIG. 9 is a flowchart including an operation which is performed after the operation illustrated in FIG. 3;

FIGS. 10 to 11 are views explaining how a statistical model is changed when checkup data of patients with a disease which do not coincide with a statistical model generated using data of patients with a disease stored in a population DB is updated in the population DB;

FIG. 12 is a block diagram of a patient's constitutional peculiarity analyzing apparatus according to another embodiment of the present invention; and

FIG. 13 is a hardware diagram of a patient's constitutional peculiarity analyzing apparatus according to another embodiment of the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

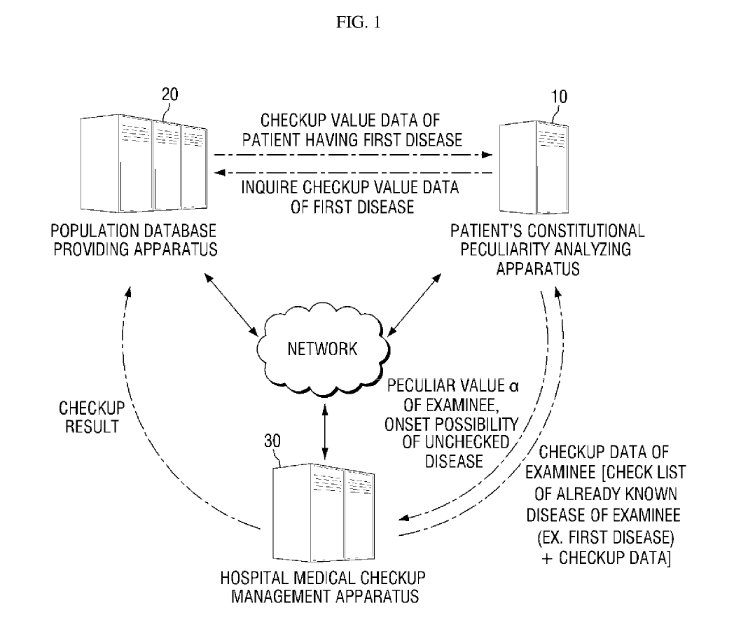

Hereinafter, a configuration and an operation of a patient's constitutional peculiarity analyzing system according to an embodiment of the present invention will be described with reference to FIG. 1. The patient's constitutional peculiarity analyzing system according to an embodiment may comprise, as illustrated in FIG. 1, a patient's constitutional peculiarity analyzing apparatus 10, a population database providing apparatus 20, and a hospital medical checkup management apparatus 30.

The hospital medical checkup management apparatus 30 manages medical checkup data of examinees who have the medical checkup. The checkup data is processed in a predetermined format to be provided to the population database providing apparatus 20. The hospital medical checkup management apparatus 30 may add a list of diseases of each examinee to the checkup data to provide the checkup data to the population database providing apparatus 20. In one embodiment, the hospital medical checkup management apparatus 30 does not provide checkup data of an examiner who does not have a disease to the population database providing apparatus 20.

In one embodiment, the checkup data includes not only checkup values for a checkup item by blood examination and a biopsy but also checkup values for a checkup item related with a life habit obtained by a survey. A user device (not illustrated) such as a biometric information collecting device, a wearable device, and a smart phone is connected to the hospital medical checkup management device through a network and the checkup data may further comprise a checkup value for a checkup item related with a life habit collected by the user device. For example, the checkup data may include exercise amount information of the examinee which is collected by the wearable device such as a smart watch.

The population database providing apparatus 20 stores, updates, and deletes population database including checkup values for every checkup item of an individual. The population database further includes information on a disease of the individual. For example, disease codes of diseases of the individual at the time of checkup may match the records of the individual. When the population database providing apparatus 20 receives a request to provide checkup value data of a patient with a first disease (for example, diabetes) from the patient's constitutional peculiarity analyzing apparatus 10, the population data providing apparatus 20 provides checkup value data of the patient with the first disease included in the population database to the patient's constitutional peculiarity analyzing apparatus 10.

In the meantime, the hospital medical checkup management apparatus 30 transmits checkup data of an examinee who answers the survey that the examinee has the first disease to the patient's constitutional peculiarity analyzing apparatus 10 to request analysis of the constitutional peculiarity of the examinee. The patient's constitutional peculiarity analyzing apparatus 10 receives the checkup data to check whether the checkup value of the examinee is statistically similar to the checkup value of the patient with the first disease recorded in the population database.

In one embodiment, in order to check whether the checkup value data of the examinee is statistically similar to the checkup value of the patient with the first disease, the patient's constitutional peculiarity analyzing apparatus 10 may generate a statistical model of the first disease using the checkup values of the patients with the first disease provided from the population database providing apparatus 20. A method of checking whether the checkup value of the examinee is statistically similar to the checkup value recorded in the population database and a method of generating the peculiar value by the patient's constitutional peculiarity analyzing apparatus 10 will be described in more detail below.

When the checkup value of the examinee is not statistically similar to checkup values of patients with the first disease recorded in the population database, it may be understood that the examinee has an organic peculiarity, which is different from a plurality of patients of the first disease. In this case, the patient's constitutional peculiarity analyzing apparatus 10 generates a peculiar value of the examinee. The peculiar value of the examinee may be understood to contain the organic peculiarity of the examinee. For example, the peculiar value of the examinee may be a set of values indicating an immune status with respect to the checkup items (or a pathogenetic factor, an environmental factor).

The peculiar value of the examinee may be utilized in various fields in order to provide a medical service personalized for the examinee. For example, the patient's constitutional peculiarity analyzing apparatus 10 transmits the generated peculiar value to the hospital medical checkup management apparatus 30 and the hospital medical checkup management apparatus 30 may transmit the peculiar value to an in-house personalized prescribing apparatus (not illustrated). The personalized prescribing apparatus adjusts a prescription which is already created for the examinee using the peculiar value or transmits the peculiar value to a terminal of a doctor so that a family doctor of the examinee is guided to adjust the prescription which has been already created based on the peculiar value.

The patient's constitutional peculiarity analyzing apparatus 10 may predict onset of a disease which has not been checked by the examinee using the peculiar value. It is assumed that the survey is performed by suggesting first to tenth diseases to the examinee to check the diseases that the examinee already has. It is assumed that in the survey, the examinee answers that the examinee has the first disease but does not have the second to tenth diseases. It is also assumed that the examinee actually has the second disease. The patient's constitutional peculiarity analyzing apparatus 10 may determine whether the checkup data of the examinee coincides with a second disease statistical model which is generated using data of patients with the second disease from the population database. In this case, the patient's constitutional peculiarity analyzing apparatus 10 reflects, as a weight, the peculiar value to some checkup values among the checkup data of the examinee and then determines whether the checkup values coincide with the second disease statistical model.

When the organic peculiarity of the examinee is considered, if the checkup data is compared with the second disease statistical model as the checkup value is, without considering the peculiar value, it is determined that the checkup data does not coincide with the second disease statistical model. As a result, it is highly likely to be expected that a possibility that the examinee is caught by the second disease is low. In contrast, in the embodiment, the peculiar value is reflected as a vulnerable pathogenetic factor of which the examinee has a specifically weaker level of immunity than an average person as a weight so that it is prevented from incorrectly judging under a premise that the examinee has an average level of immunity with respect to the vulnerable pathogenetic factor. The method of predicting a disease onset possibility of the examinee using the peculiar value will be described in detail below.

When the checkup value of the examinee who answers to have the first disease is not statistically similar to the checkup value of the patients with the first disease recorded in the population database, the patient's constitutional peculiarity analyzing apparatus 10 may transmit the checkup values of the examinee to the population database providing apparatus 20 so that the checkup data of the examinee is accumulated in the population database as a new first disease onset pattern. When a checkup record of an examinee having a checkup value having a similar pattern to the examinee is sufficiently accumulated in the population database, the checkup value of the examinee may be reflected in the statistical model. Therefore, it is possible to statistically predict that other examinees having an organic peculiarity similar to that of the examinee have an onset possibility of the first disease.

As described above, the population database providing apparatus 20 transmits the checkup value of patients of a specific disease to the patient's constitutional peculiarity analyzing apparatus 10 in response to the request of the patient's constitutional peculiarity analyzing apparatus 10. The patient's constitutional peculiarity analyzing apparatus 10 generates a statistical model of the first disease using the checkup value of patients of the first disease provided from the population database providing apparatus 20. When there are lots of the patients with the first disease, there may be problems in the view of a performance due to over network traffic load between the population database providing apparatus 20 and the patient's constitutional peculiarity analyzing apparatus 10.

In order to solve the problems, differently from FIG. 1, the population database providing apparatus 20 and the patient's constitutional peculiarity analyzing apparatus 10 may be physically implemented in a single computing device.

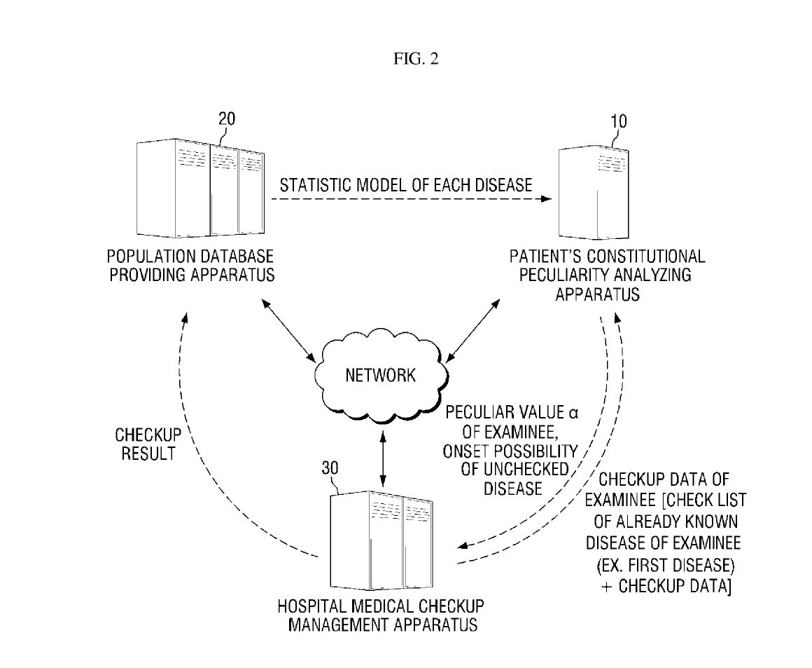

In order to solve the problems, as illustrated in FIG. 2, the population database providing apparatus 20 may provide a disease statistical model generated by the checkup value of the patient with the disease. That is, in this case, the population database providing apparatus 20 directly generates the statistical model using the checkup value of each of the patients of the disease and provides the generated statistic model to the patient's constitutional peculiarity analyzing apparatus 10. A method of generating the statistic model using the checkup value of each of the patients of the disease will be described in detail below.

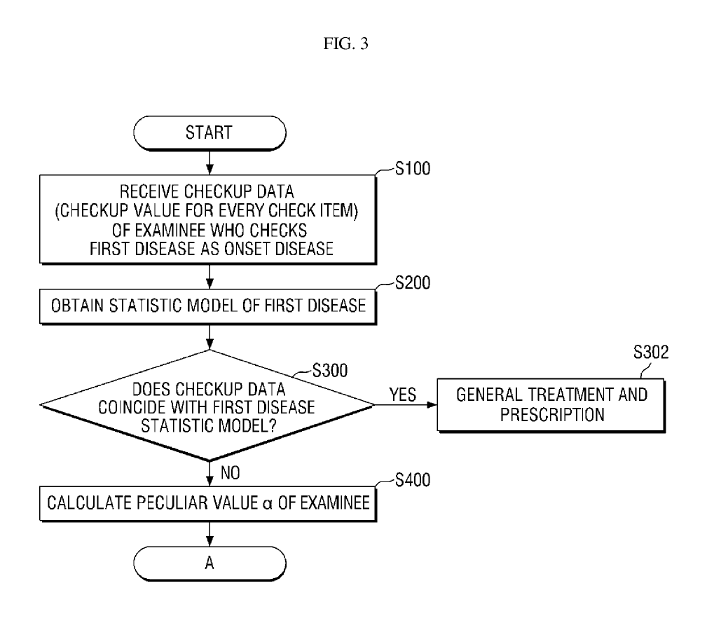

Hereinafter, a patient's constitutional peculiarity analyzing method according to several embodiments of the present invention will be described with reference to FIGS. 3 to 11. The patient's constitutional peculiarity analyzing method may be performed by a computing device. The computing device may be the patient's constitutional peculiarity analyzing apparatus 10 illustrated in FIGS. 1 and 2. Hereinafter, it should be noted that a principle agent who performs operations included in the patient's constitutional peculiarity analyzing method may be omitted for the convenience of understanding.

FIG. 3 is a flowchart schematically illustrating a patient's constitutional peculiarity analyzing method according to an embodiment. As illustrated in FIG. 3, when checkup data of an examinee who checks to have a specific disease (a first disease in FIG. 3) is received in step S100, a statistic model of the specific disease is obtained in step S200, it is determined whether the received checkup data coincides with the statistic model in step S300, and when it is determined that the checkup data does not coincide with the statistic model, a peculiar value (in a part of the description or drawings, the peculiar value may be denoted by a symbol “α”) of the examinee is calculated in step S400.

In the meantime, when it is determined that the received checkup data coincides with the statistic model, it means that a level of an organic peculiarity of the examinee is included within a general scope. Therefore, general medical treatment and prescription may be provided to the examinee (step S302).

A target to which a peculiar value is generated according to the embodiments is a patient having a level of an organic peculiarity which is not included within the general scope. In the embodiments of the present invention, a patient whose checkup data does not coincide with the statistic model of the specific disease even though the patient answers the survey that the patient has a specific disease is considered as a patient having a level of an organic peculiarity which is not included within the general scope.

Hereinafter, detailed operations of the patient's constitutional peculiarity analyzing method which has been described with reference to FIG. 3 will be described in more detail.

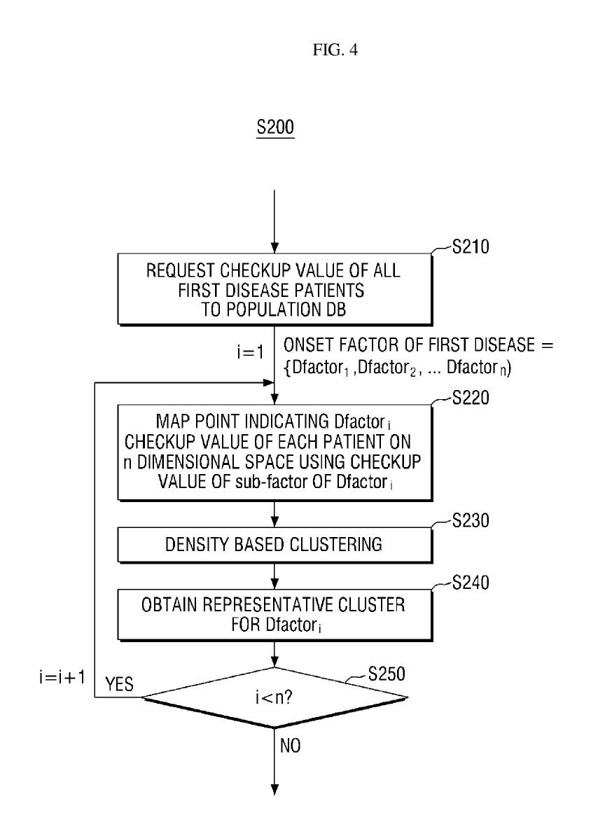

First, a method of generating a statistic model of a specific disease (a first disease) will be described in more detail with reference to FIG. 4.

First, a request for a checkup value of all patients with a first disease may be sent to a population database in step S210. In one embodiment, a request only for a checkup value related with an onset factor of the first disease among the checkup values of the patient with the first disease may be sent to the population database. Hereinafter, onset factors of the first disease is represented as {Dfactor₁, Dfactor₂, . . . Dfactorₙ}. Table 1 is an example of an onset factor of the first disease.

TABLE 1

| Environmental Factor | Onset contribution ratio |
|---|---|
| Dietary habit (K₁) | 50% |
| Exercise amount (L₁) | 30% |
| Fatness index (K₂) | 10% |
| Stress (K₃) | 6% |
| Nutritional balance (L₂) | 3% |
| Others (L₃) | 1% |

In the meantime, in several embodiments of the present invention, each onset factor is configured by sub-onset factors (sub-factors). That is, Dfactor₁={Dfactor₁₁, Dfactor₁₂, Dfactor₁₃, . . . , Dfactor₁ₙ} For example, in an example of Dfactor₁, =Dietary habit (K₁), the dietary habit={meal size (Dfactor₁₁), whether to use mixed grain (Dfactor₁₂)}.

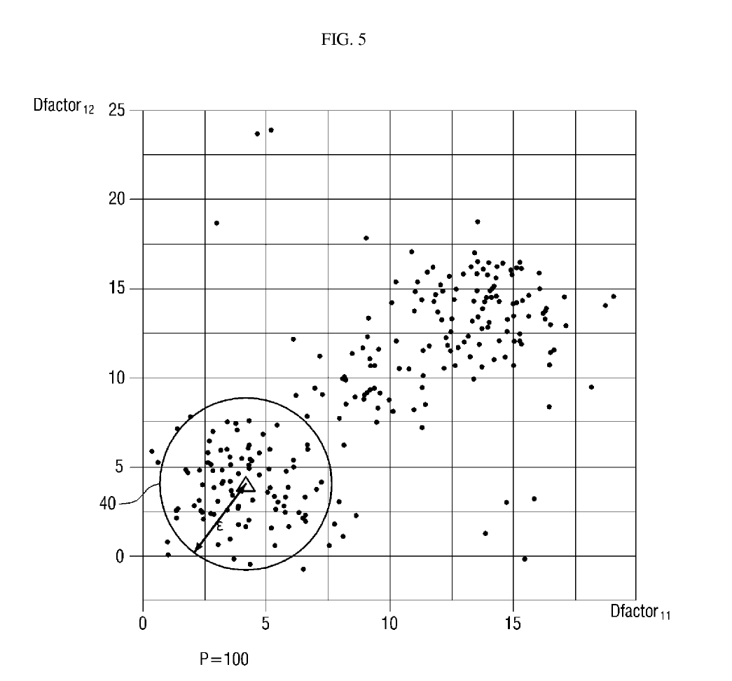

Next, points indicating the checkup value of the patients of the population database is mapped on an n-dimensional space (n is the number of sub onset factors of Dfactorᵢ) for every onset factor in step S220. In an example of Dfactor₁, a point indicating the checkup value of the patient of the population database is represented on a two-dimensional plane where a first axis is a value of Dfactor₁₁ and a second axis is a value of Dfactor₁₂ (see FIG. 5).

Next, a representative cluster for Dfactor₁ is obtained by density-based spatial clustering in steps S230 and S240. In this case, when a predetermined number (p) of points is present within a radius ε with all points, which are mapped on the n-dimensional space, as a center, it is determined that the representative cluster is established.

In one embodiment, when the predetermined number (p) of points is not present within the radius ε, at least one of the radius ε and the number p is adjusted and then when an adjusted number (p) of points is present within the adjusted radius ε with all points, which are mapped on the n-dimensional space, as a center, it is determined that the representative cluster is established. In this case, at least one of the radius ε and the number p may be adjusted by increasing the radius ε or decreasing the number p.

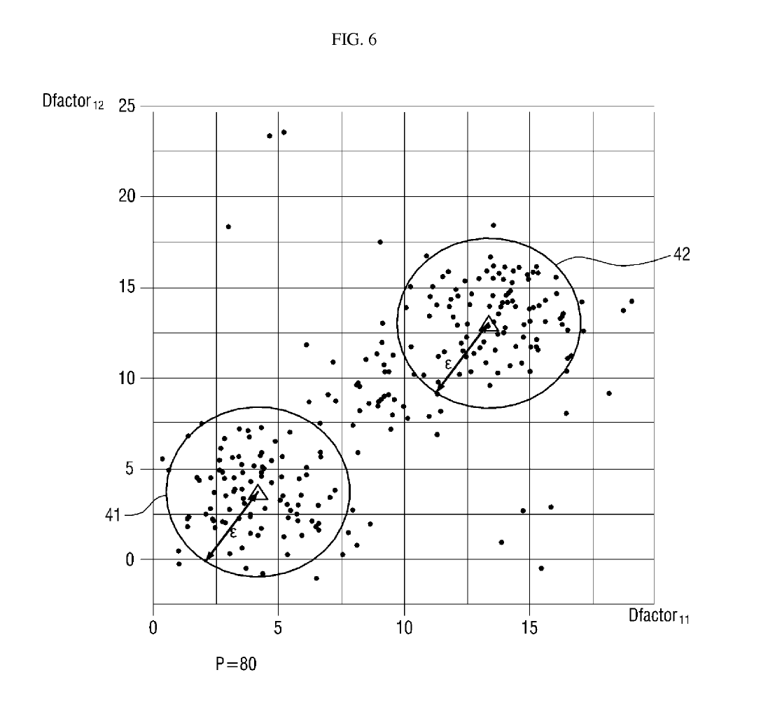

In one embodiment, a plurality of representative clusters may be established. In FIG. 6, a situation when two representative clusters 41 and 42 are established on a two-dimensional plane is illustrated.

In another embodiment, when there is a plurality of points satisfying a representative cluster establishing requirement, one center where points are present within the radius ε as many as possible is selected from the plurality of centers and only one representative cluster is selected with respect to the center.

In another embodiment, when there is a plurality of points satisfying a representative cluster establishing requirement, one center where points are present as many as possible is selected while narrowing the radius ε and only one representative cluster is selected with respect to the center. Further, in another embodiment, when there is a plurality of points satisfying a representative cluster establishing requirement, one center where points are present as many as possible is selected while broadening the radius ε and only one representative cluster is selected with respect to the center. In FIG. 5, a situation when only one representative cluster 40 is established on a two-dimensional plane is illustrated.

The representative cluster for Dfactor₁ is used as a statistic model for Dfactor₁.

A series of operations S220, S230, and S240 for obtaining the statistic model for Dfactorᵢ are additionally performed for each Dfactorᵢ (2<=I<=n) in step S250. The statistic model of each onset factor configures the statistic model of the first disease.

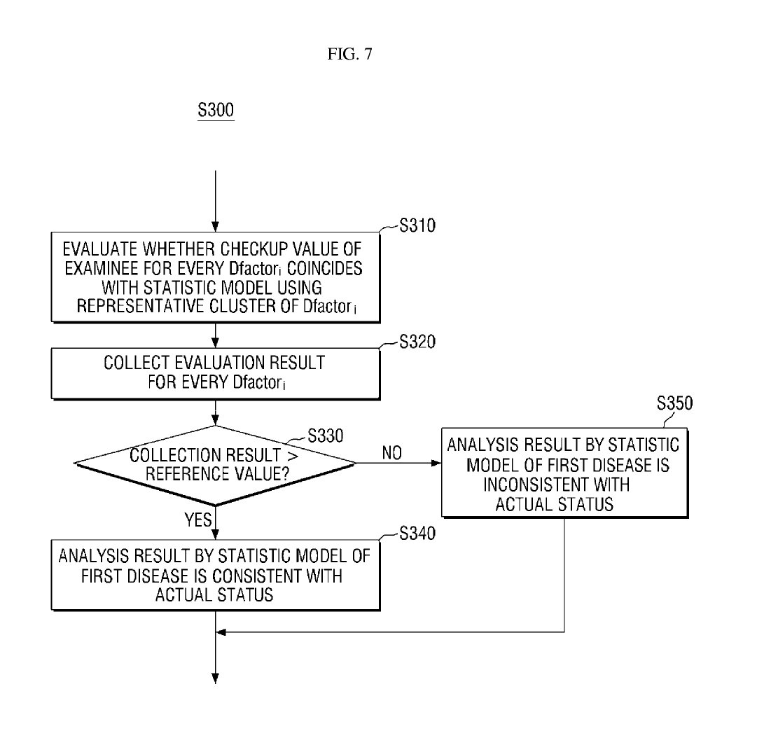

Next, a method S300 of determining whether the checkup data of the examinee coincides with the statistic model will be described in more detail with reference to FIG. 7.

First, whether the checkup value for every Dfactorᵢ of the examinee coincides with the statistic model of Dfactorᵢ is repeatedly evaluated for all Dfactorᵢ in step S310. In this case, the evaluating whether the checkup value of Dfactorᵢ coincides with the statistic model of Dfactorᵢ includes A step of mapping an examinee point indicating a checkup value for the first onset factor of the examine onto the n-dimensional space using the checkup values for a plurality of sub onset factors which is contained in the first onset factor Dfactor1 of the checkup data of the examinee and B step of determining whether the examinee point belongs to the representative cluster for the first onset factor to determine whether the checkup value for the first onset factor of the examinee coincides with the first disease statistic model.

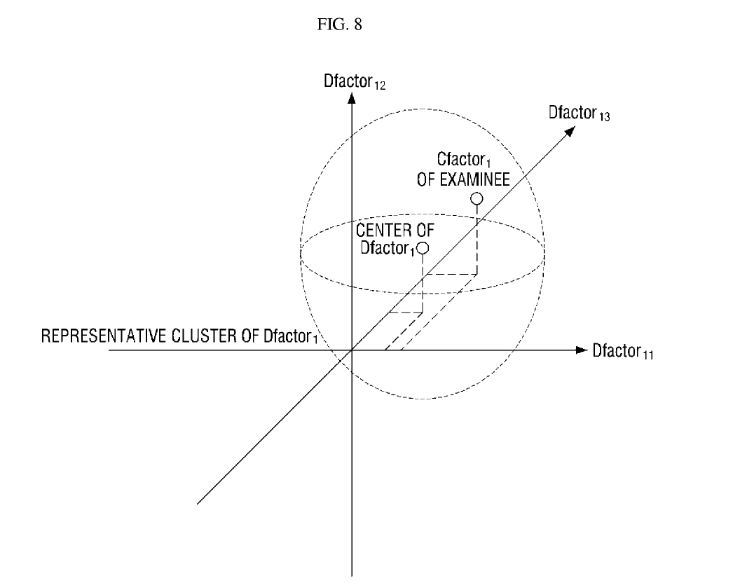

A step and B step will be described with reference to FIG. 8. The checkup data of the examinee does not separately include a checkup value of Dfactor₁ (dietary habit), but includes only checkup values of Dfactor₁₁ (meal size), Dfactor₁₂ (whether to use mixed grain), and Dfactor₁₃ (vegetable intake ratio). In this case, the checkup value (Cfactor₁) for Dfactor₁ of the examinee may be represented on a three-dimensional space where a first axis is a value of Dfactor₁₁ (meal size), a second axis is a value of Dfactor₁₂ (whether to use mixed grain), and a third axis is a value of Dfactor₁₃ (vegetable intake ratio), as one point.

In one embodiment, a distance (Euclidean distance) between a point corresponding to Cfactor₁ and the center of the representative cluster Dfactor₁ is equal to or smaller than the radius ε of the representative cluster of Dfactor₁, it is evaluated that the checkup value for the first onset factor of the examinee coincides with the first disease statistic model. In this case, the distance (Euclidean distance) between the point corresponding to Cfactor₁ and the center of the representative cluster Dfactor₁ exceeds the radius ε of the representative cluster of Dfactor₁, it is evaluated that the checkup value for the first onset factor of the examinee does not coincide with the first disease statistic model.

In another embodiment, if the distance (Euclidean distance) between the point corresponding to Cfactor₁ and the center of the representative cluster Dfactor₁ is between a minimum value of a distance between the center of the representative cluster Dfactor₁ and another point of the representative cluster Dfactor₁ and a maximum value thereof, it is evaluated that the checkup value for the first onset factor of the examinee coincides with the first disease statistic model and if not, it is evaluated that the checkup value for the first onset factor of the examinee does not coincide with the first disease statistic model.

Next, evaluation results for every Dfactorᵢ of the checkup data are collected in step S320. It is assumed that the evaluation result for every Dfactorᵢ for the first disease of the checkup data of the examinee having the first disease is as represented in Table 2. Hereinafter, several embodiments which determine whether the checkup data of the examinee having the first disease coincides with the statistic model of the first disease as a whole will be described.

TABLE 2

| | Onset contribution ratio | Whether to coincide |
|---|---|---|
| Dfactorᵢ | (DCRᵢ) | with statistic model |
| Dietary habit (K₁) | 50% | ◯ |
| Exercise amount (L₁) | 30% | X |
| Fatness index (K₂) | 10% | ◯ |
| Stress (K₃) | 6% | ◯ |
| Nutritional balance (L₂) | 3% | X |
| others (L₃) | 1% | X |

In a first embodiment which determines whether the checkup data coincides with the statistic model of the first disease, only when it is determined that the checkup data coincides with statistic models of all Dfactorᵢ, it is finally determined that the checkup data coincides with the statistic model of the first disease. In other words, when it is determined that the checkup data does not coincide with a statistic model of any one of Dfactorᵢ, it is considered that the checkup data does not coincide with the statistic model of the first disease as a whole.

In a second embodiment which determines whether the checkup data coincides with the statistic model of the first disease, the evaluation result of the checkup data for every Dfactorᵢ may be collected as represented in Table 3. In Table 3, when it is determined that the checkup value for Dfactorᵢ of the examinee coincides with the statistic model of Dfactorᵢ a point determined based on an onset contribution ratio of Dfactorᵢ is applied to Dfactorᵢ and applied points are added.

TABLE 3

| | Onset contribution | Whether to coincide | |
|---|---|---|---|
| Dfactorᵢ | ratio(DCRᵢ) | with statistic model | Point |
| Dietary habit (K₁) | 50% | ◯ | 50 |
| Exercise amount (L₁) | 30% | X | 0 |
| Fatness index (K₂) | 10% | ◯ | 10 |
| Stress (K₃) | 6% | ◯ | 7 |
| Nutritional balance | 3% | X | 0 |
| (L₂) | | | |
| others (L₃) | 1% | X | 0 |

| | |
|---|---|
| Total | 67 |

If the added point values exceed a reference value for the first disease in step S330, it is finally determined that the checkup data of the examinee coincides with the first disease statistic model obtained from the checkup value of the patient with the first disease in step S340, and if not, it is finally determined that the checkup data of the examinee does not coincide with the first disease statistic model in step S350. In an example represented in Table 3, when the reference value for the first disease is 80, the examinee is finally determined as a patient who has an organic peculiarity which does not coincide with the first disease statistic model.

In one embodiment, the reference value may be set to vary depending on diseases. In another embodiment, the same reference value may be set for all disease.

In the present embodiment, in order to determine whether the checkup data of the examinee coincides with the statistic model, it is summarized that the following operations are performed.

First operation: When an examinee point indicating a checkup value of the examinee for the first onset factor belongs to the representative cluster for the first onset factor, a point determined based on an onset contribution ratio of the first onset factor is applied.

Second operation: The step of assigning a point is repeated for the second to M onset factors.

Third operation: When the added values of the applied points exceed a reference value for the first disease, it is determined that the checkup data of the examinee coincides with a first disease statistic model obtained from the checkup value of a patient with the first disease.

In a third embodiment which determines whether the checkup data coincides with the statistic model of the first disease, the evaluation result of the checkup data for every Dfactorᵢ may be collected as represented in Table 4. In Table 4, a distance (Euclidean distance) between the center of the representative cluster for every Dfactorᵢ and Cfactorᵢ which is data for a checkup value corresponding to Dfactorᵢ among checkup data of the examinee, on an n (n is the number of sub-onset factors of Dfactorᵢ) dimensional space is further represented. The distance is a value calculated when it is determined whether to coincide with the statistic model for each Dfactorᵢ.

TABLE 4

| | | Whether | Distance | |
|---|---|---|---|---|
| | | to | (ΔCFactorᵢ) | |
| | | coincide | between center of | |
| | Onset | with | representative | Adjusted |
| | contribution | statistic | cluster and | distance |
| DFactorᵢ | ratio (DCRᵢ) | model | CFactorᵢ | (= point) |
| Dietary habit | 50% | ◯ | 5 | 250 (50 * 5) |
| (K1) | | | | |
| Exercise | 30% | X | 30 | 0 |
| amount (L1) | | | | |
| Fatness | 10% | ◯ | 7 | 70 (10 * 7) |
| index (K2) | | | | |
| Stress (K3) | 6% | ◯ | 6 | 42 (7 * 6) |
| Nutritional | 3% | X | 40 | 0 |
| balance (L2) | | | | |
| others (L3) | 1% | X | 35 | 0 |

| | |
|---|---|
| Total | 362 |

In the method represented in Table 4, the same point is not applied to all the examinee points when it is determined the examinee points belong to the representative cluster, but even when the examinee points belong to the representative cluster, it is evaluated how close to the center of the representative cluster, which is different from the method represented in Table 3. Further, in the method represented in Table 4, as the total point is lower, it is finally determined to coincide with the statistic model, which is different from the method represented in Table 3.

In the present embodiment, in order to determine whether the checkup data of the examinee coincides with the statistic model, it is summarized that the following operations are performed.

First operation: A distance between an examinee point indicating a checkup point for a first onset factor Dfactor₁ of an examinee and a center of a representative cluster for a first onset factor Dfactor₁ is calculated.

Second operation: The distance between the examinee point and the center is adjusted by reflecting a weight determined based on an onset contribution ratio of the first onset factor Dfactor₁ to the calculated distance.

Third operation: An operation of adjusting the distance is repeated for second to M onset factors second onset factor Dfactor₂ to M-th onset factor Dfactor_{M}.

Fourth operation: When the added values of the adjusted distance is below a reference value for the first disease, it is determined that the checkup data of the examinee coincides with a first disease statistic model obtained from the checkup value of a patient with the first disease.

In one embodiment, the reference value may be set to vary depending on the diseases. In another embodiment, the same reference value may be set for all diseases.

Until now, embodiments which determine whether the checkup data of the examinee having the first disease coincides with the statistic model of the first disease as a whole will be described. Hereinafter, an operation which calculates a peculiar value of an examinee who is determined that the checkup data does not coincide with the statistic model of the first disease but actually has the first disease will be described in detail.

Hereinafter, a first embodiment which calculates a peculiar value will be described.

According to this embodiment, the peculiar value of the examinee may be calculated only using a part of the checkup values which coincide with the statistic model of the first disease among the checkup data.

TABLE 5

| | Onset contribution | Whether to coincide with |
|---|---|---|
| Dfactorᵢ | ratio (DCRᵢ) | statistic model |
| Dietary habit (K1) | 50% | X |
| Exercise amount (L1) | 30% | X |
| Fatness index (K2) | 10% | ◯ |
| Stress (K3) | 6% | ◯ |
| Nutritional balance (L2) | 3% | X |
| others (L3) | 1% | X |

It is assumed that checkup data of an arbitrary examinee having a first disease coincides with a statistic model of the first disease as represented in Table 5. According to the analyzing result of Table 5, in a dietary habit item in which the examinee has a high onset contribution ratio, the examinee has different dietary habit from exercise amounts of patients with the first disease and also in an exercise amount item having a second higher onset contribution ratio, the examinee has an exercise amount which is different from an exercise amount of the patients with the first disease. That is, the examinee has proper dietary habit and an appropriate exercise amount. Nevertheless, from the fact that the examinee gets the first disease, it is known that influence of the fatness index item and the stress item on the first disease of the examinee is larger than that of general people.

In order to reflect such an organic peculiarity, a peculiar value α for the examinee may be calculated by the following equation. Equation 1 is provided for Table 5 in order to calculate a peculiar value α for the examinee according to the embodiment. In the following Equation, “T” indicates a reference value of a patient.

(CFactor₃*α)+(CFactor₄*α)=T Equation 1

CFactor₃ indicates a checkup value with respect to a fatness index and CFactor₃ indicates a checkup value for a stress index. As represented in Equation 1, in the present embodiment, a checkup value which does not coincide with the statistic model of the first disease among checkup data is not used to calculate the peculiar value.

Hereinafter, CFactorᵢ refers to a distance between an examinee point indicating a checkup value for Dfactorᵢ and an origin of the n-dimensional space. That is, CFactorᵢ is a value obtained by digitizing a position of the examinee point present on the n-dimensional space as a scalar amount.

When Equation 1 is generalized, according to Equation 1, CFactorᵢ*α is calculated for every checkup value which coincides with the statistic model, among the checkup values of the checkup data and a value obtained by adding entire CFactorᵢ*α becomes a reference value of patients.

In one embodiment, the reference value of patients T is a predetermined value. For example, the reference value of patients T may be “1”.

In another embodiment, the reference value of patients T may be a value obtained by calculating to add a checkup value median DF_MIDᵢ for every onset factor Dfactorᵢ for all onset factors. Equation 2 is an equation which calculates the reference value of patients T in this embodiment.

Σᵢ₌₁^{M}DF_MIDᵢ=T Equation 2
(M is a number of onset factors)

The checkup value median DF_MIDᵢ for DFactorᵢ may be a distance between a center point of the representative cluster of Dfactorᵢ and the origin of the n dimensional space or an average value of distances between points belonging to the representative cluster of Dfactorᵢ and the origin of the n dimensional space.

Hereinafter, a second embodiment which calculates a peculiar value will be described.

In Equation 1, the onset contribution ratio DCRᵢ of each Dfactorᵢ is not reflected. In contrast, according to the embodiment, the peculiar value may be calculated so that a total of adjusted checkup values obtained by reflecting both a first weight which is an onset contribution ratio for a checkup item of the checkup value and a second weight which is the peculiar value to the checkup value which coincides with the first disease statistic model among the checkup data becomes the reference value of patients T. Equation 3 is provided for Table 5 in order to calculate a peculiar value α for the examinee according to the embodiment.

(CFactor₃*α*0.1)+(CFactor₄*α*0.07)=T Equation 3

In one embodiment, the reference value of patients T is a predetermined value. For example, the reference value of patients T may be “1”.

In another embodiment, the reference value of patients T may be a value obtained by reflecting an onset contribution ratio to a checkup value median DF_MIDᵢ for every onset factor Dfactorᵢ as a weight and then adding the values. Equation 4 is an equation which calculates the reference value of patients T in this embodiment.

Σᵢ₌₁^{M}(DF_MIDᵢ*DCRᵢ)=T Equation 4
(M is a number of onset factors)

The checkup value median DF_MIDᵢ for DFactorᵢ may be a distance between a center point of the representative cluster of Dfactorᵢ and the origin of the n dimensional space or an average value of distances between points belonging to the representative cluster of Dfactorᵢ and the origin of the n dimensional space.

Hereinafter, a third embodiment which calculates a peculiar value will be described.

According to the embodiment, when the peculiar value is calculated, a weight for the onset factor which coincides with the statistic model is different from a weight for the onset factor which does not coincide with the statistic model. That is, differently from the first embodiment and the second embodiment which calculate the peculiar value, a checkup value Cfactorᵢ of an onset factor whose checkup data does not coincide with the statistic model is also used to calculate the peculiar value.

According to the first embodiment and the second embodiment which calculate the peculiar value, a weight for a checkup value Cfactorᵢ of an onset factor whose checkup data coincides with the statistic model is the peculiar value α and a weight for a checkup value Cfactorᵢ of an onset factor whose checkup data does not coincide with the statistic model is 0. In contrast, according to the third embodiment which calculates the peculiar value, a first weight is applied for a checkup value Cfactorᵢ of an onset factor whose checkup data coincides with the statistic model and a second weight is applied to a checkup value Cfactorᵢ of an onset factor whose checkup data does not coincide with the statistic model.

Both the first weight and the second weight may be designated using the peculiar value α. For example, the first weight may be Aα and the second weight may be Bα (A≠B).

In one embodiment, the first weight may be a positive (+) value but the second weight may be a negative (−) value.

In one example embodiment, both the first weight and the second weight may be positive (+) values but the first weight may be larger than the second weight.

According to the embodiment, the following description may be made. The following Equation 5 is for Table 5. In Equation 5, it is premised that the first weight is 2α and the second weight is α.

(CFactor₁*α*0.5)+(CFactor₂*α*0.3)+(CFactor₃*α*0.1)+(CFactor₄*2α*0.07)+(CFactor₅*α*0.03)+(CFactor₆*α*0.01)=T Equation 5

In one embodiment, the reference value of patients T is a predetermined value. For example, the reference value of patients T may be “1”.

In another embodiment, the reference value of patients T may be a value obtained by reflecting an onset contribution ratio to a checkup value median DF_MIDᵢ for every onset factor Dfactorᵢ as a weight value and then adding the values. Equation 4 is an equation which calculates the reference value of patients T in this embodiment.

The checkup value median DF_MIDᵢ for DFactorᵢ may be a distance between a center point of the representative cluster of Dfactorᵢ and the origin of the n dimensional space or an average value of distances between points belonging to the representative cluster of Dfactorᵢ and the origin of the n dimensional space.

The present embodiment may be summarized as follows:

First rule: A peculiar value of the examinee is calculated such that a sum of the adjusted checkup values for each onset factor of the first disease is equal to the reference value of patients T.

Second rule: The adjusted checkup value for a specific onset factor is a value obtained by reflecting a personalized weight for the specific onset factor to the checkup value of the examinee with respect to the specific onset factor.

Third rule: The personalized weight for the specific onset factor is set to be a first weight designated using a peculiar value α of the examinee when the checkup value of the examinee for the specific onset factor coincides with the first disease statistic model for the specific onset factor and set to be a second weight designated using a peculiar value α of the examinee when the checkup value of the examinee for the specific onset factor does not coincide with the first disease statistic model for the specific onset factor.

Fourth rule: The first weight is different from the second weight.

Hereinafter, a fourth embodiment which calculates a peculiar value will be described.

According to this embodiment, when a peculiar value is calculated, weights may vary depending on onset factors Dfactorᵢ which coincides with the statistic model. Equation 6 for calculating a peculiar value α of an examinee according to the embodiment is provided.

$${\sum }_{i = 1}^{M} ( {CFactor}_{i} * {A}_{i} α * {DCR}_{i} ) = T \\ ( M is a number of onset factors ) \qquad Equation 6$$

As represented in Equation 6, a weight Aᵢα for each onset factor Dfactor1 is determined using a peculiar value α of the examinee. For example, Ai may be a value determined based on a distance which is an Euclidean distance between an examinee point indicating a checkup value for Dfactorᵢ and the center of the representative cluster of DFactorᵢ. For example, Aᵢ may be a value which is proportional to the distance or a value which is inversely proportional to the distance. It should be noted that the embodiment of the present invention is not limited to the example of setting Ai, but Ai may be set by various criteria which are not mentioned above.

In one embodiment, the reference value of patients T is a predetermined value. For example, the reference value of patients T may be “1”.

In another embodiment, the reference value of patients T may be a value obtained by reflecting an onset contribution ratio to a checkup value median DF_MIDᵢ for every onset factor Dfactorᵢ as a weight value and then adding the values. Equation 4 is an equation which calculates the reference value of patients T in this embodiment.

The checkup value median DF_MIDᵢ for DFactorᵢ may be a distance between a center point of the representative cluster of Dfactorᵢ and the origin of the n dimensional space or an average value of distances between points belonging to the representative cluster of Dfactorᵢ and the origin of the n dimensional space.

Hereinafter, a fifth embodiment which calculates a peculiar value will be described.

According to this embodiment, when a peculiar value is calculated, weights may vary depending on onset factors Dfactorᵢ which coincides with the statistic model. That is, according to this embodiment, different peculiar values may be calculated for every onset factor. In this case, the peculiar value for the examinee refers to a series of peculiar values for every onset factor. Equation 7 for calculating a peculiar value (αᵢ, 1<=I<=M) of an examinee according to the embodiment is provided.

$${\sum }_{i = 1}^{M} ( {CFactor}_{i} * {α}_{i} * {DCR}_{i} ) = T \qquad Equation 7$$

According to the embodiment, Equation 7 for a first disease, Equation 7 for a second disease, . . . and Equation 7 for an n-th disease are generated and a simultaneous equation is reduced using the generated equations to obtain a, for each onset factor Dfactorᵢ.

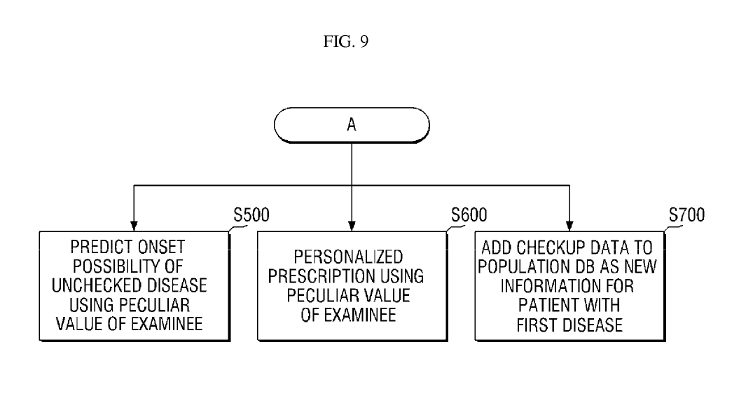

Hereinafter, how to utilize a peculiar value of an examinee which is generated by the above-described method will be explained with reference to FIG. 9.

First, it is possible to predict whether other diseases which is not checked in a survey occurs in advance using the peculiar value in step S500.

It is assumed that the survey is performed by suggesting first to tenth diseases to the examinee to check the diseases that the examinee already has. It is assumed that in the survey, the examinee answers that the examinee has the first disease but does not have the second to tenth diseases. It is also assumed that the examinee actually has the second disease. The patient's constitutional peculiarity analyzing apparatus 10 may determine whether the checkup data of the examinee coincides with a second disease statistical model which is generated using data of patients of the second disease of the population database.

It is assumed that as a result of comparing the checkup data of the examinee with a statistic model for the first disease, the checkup data does not coincide with the statistic model and a peculiar value of the examinee is calculated according to the first embodiment which calculates the peculiar value. It is assumed that the result is as represented in Table 5 and an onset factor of a second disease statistic model includes a fatness index and a stress index. In this case, when it is determined whether the checkup data of the examinee coincides with the second disease statistic model, the calculated peculiar value is reflected to a checkup value of the fatness index and a checkup value of the stress index as a weight.

Next, personalized prescription may be prescribed to the examinee using the peculiar value of the examinee in step S600. As described above, the generated peculiar value may be transmitted to a personalized prescribing apparatus. The personalized prescribing apparatus adjusts a prescription which is created for the examinee using the peculiar value or transmits the peculiar value to a terminal checked by a doctor so that a family doctor is guided to adjust the prescription which has been already created based on the peculiar value.

When the checkup value of the examinee who answers to have the first disease is not statistically similar to the checkup value of the patients of the first disease recorded in the population database, the checkup values of the examinee may be transmitted to a population database providing apparatus so that the checkup data of the examinee is accumulated in the population database as a new first disease onset pattern in step S700.

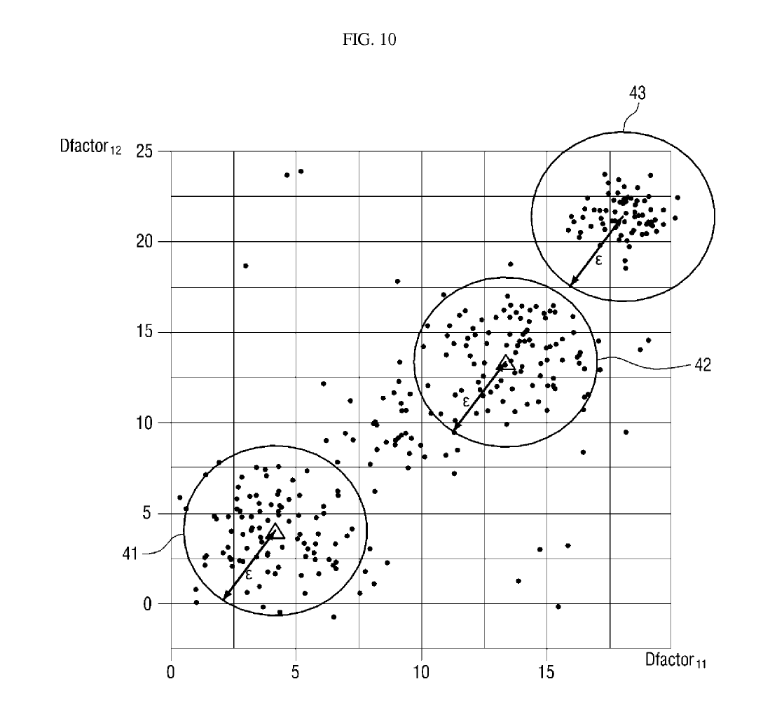

When a checkup record of an examinee having a checkup value having a similar pattern to the examinee is sufficiently accumulated in the population database, the checkup value of the examinee may be reflected in the statistical model. FIG. 10 illustrates that when checkup records of an examinee having a similar pattern of a checkup value of the above examinee are accumulated, a new representative cluster 43 is generated. Since it will be analyzed that checkup values of other examinees having a similar organic peculiarity to the examinee are included in the representative cluster 43 later, an onset possibility of the first disease may be statistically predicted.

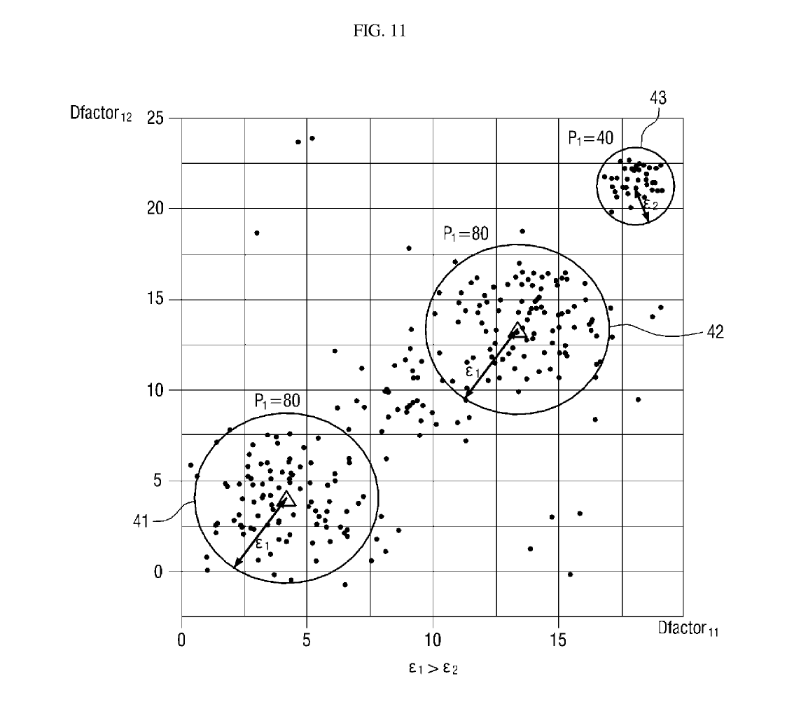

In the meantime, even though the checkup data is evaluated that the onset possibility of the first disease is low according to the existing statistic model by considering that the number of examinees having an organic peculiarity is small, a representative cluster establishment requirement actually needs to be relieved for data indicating the examinee having the first disease. FIG. 11 illustrates such an embodiment. It is confirmed that according to the existing statistic model, a representative cluster 43 of points indicating checkup data of examinees whose onset possibility of the first disease is rejected but who actually have the first disease is generated and establishment requirements (ε, p) of the representative cluster are relieved than the establishment requirements of other representative clusters 41 and 42.

The patient's constitutional peculiarity analyzing method according to several embodiments of the present invention which has been described until now with reference to FIGS. 1 to 11 may be performed by executing a computer program in a computing device. In order to carry out the embodiment, a computer program which is recorded in a recording medium and is coupled to a computing device to perform a step of receiving checkup data of an examinee having a first disease, a step of determining whether the checkup data coincides with a first disease statistic model obtained from a checkup value of a patient with the first disease, and a step of, when the checkup data does not coincide with the first disease statistic model as a result of the determination result, calculating a peculiar value of the examinee using only a part of checkup values which coincide with the first disease statistic model among the checkup data.

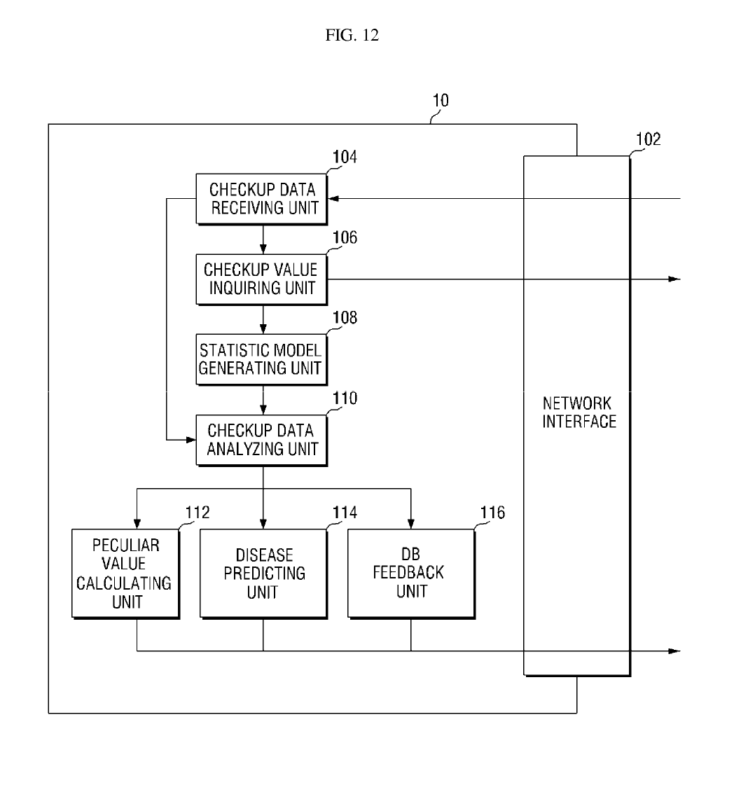

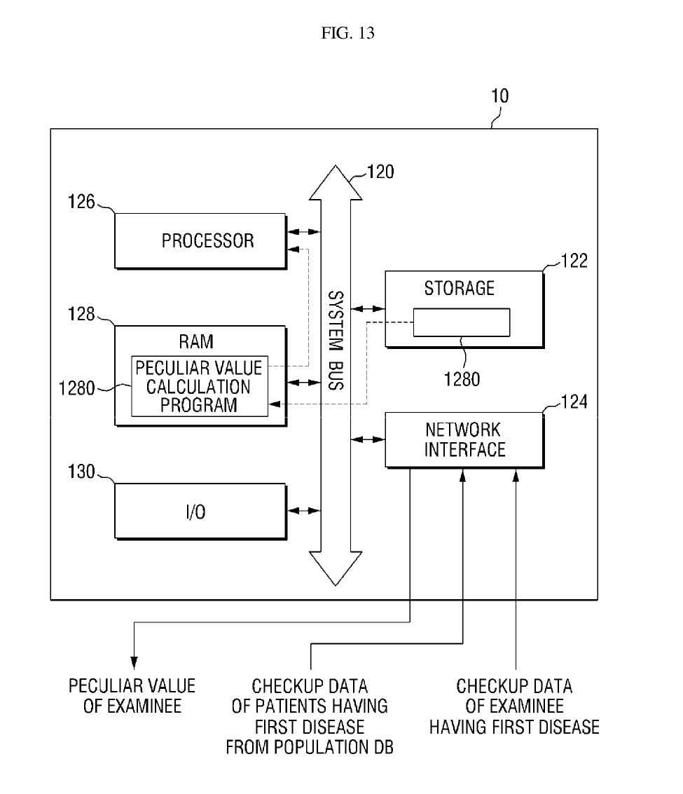

Hereinafter, a configuration and an operation of an patient's constitutional peculiarity analyzing apparatus according to another embodiment of the present invention will be described with reference to FIGS. 12 and 13.

FIG. 12 is a block diagram of a patient's constitutional peculiarity analyzing apparatus according to the embodiment of the present invention. As illustrated in FIG. 12, a patient's constitutional peculiarity analyzing apparatus according to the embodiment may include a network interface 12, a checkup data receiving unit 104, a checkup value inquiring unit 106, a statistic model generating unit 108, a checkup data analyzing unit 110, and a peculiar value calculating unit 112 and further includes a disease predicting unit 114 and a DB feedback unit 116.

When the checkup data receiving unit 104 receives checkup data of an examinee having a first disease through the network interface 102, the checkup value inquiring unit 106 requests checkup values of patients having the first disease to a population database through the network interface 102. The checkup value inquiring unit 106 processes checkup value data for an onset factor of the first disease among the checkup values of the first disease patients provided from the population database in a predetermined pattern and provides the checkup value data to the statistic model generating unit 108.

The statistic model generating unit 108 performs density based clustering on the data provided from the checkup value inquiring unit 106 to configure a representative cluster representing a checkup value for patients with the first disease of the population database for every onset factor of the first disease. The representative cluster of each onset factor configures the entire statistic model of the first disease.

The checkup data analyzing unit 110 determines whether checkup data of the examinee coincides with the generated statistic model. As a result of the analyzing result of the checkup data analyzing unit 110, when the checkup data does not coincide with the statistic model, the peculiar value calculating unit 112 calculates a peculiar value for the examinee containing an organic peculiarity or sensitivity for a specific onset factor of the examinee. The above-described embodiments may be referred for the method of calculating the peculiar value.

The peculiar value calculating unit 112 may provide the generated peculiar value to an external device through the network interface 102. The peculiar value may be utilized as basic data to provide a medical service personalized for the examinee.

The disease predicting unit 114 predicts other diseases which are not checked by the examinee (that is, the examinee does not recognize susceptibility to catching the diseases). In this case, the peculiar value is reflected to a part of the checkup value of the checkup data to adjust the checkup value and then it is determined whether the checkup data including the adjusted value coincides with a statistic model of other diseases.

When the checkup value of the examinee who answers to have a specific disease is not statistically similar to the checkup value of the patients with the specific disease recorded in the population database, the DB feedback unit 116 transmits the checkup values of the examinee to a population database providing apparatus so that the checkup data of the examinee is accumulated in the population database as a new first disease onset pattern.

Until now, components of FIG. 12 may refer to software or hardware such as a field programmable gate array (FPGA) or an application specific integrated circuit (ASIC). However, the components are not limited to the software or the hardware but may be configured to be provided in an addressable storage medium or configured to execute one or more processors. A function provided in the components may be implemented by subdivided components and a plurality of components is combined to be implemented as one component which performs a specific function.

FIG. 13 is a diagram of a disease onset predicting apparatus 100. The patient's constitutional peculiarity analyzing apparatus 10 may comprise a processor 126 which executes operations, a storage 122 in which constitutional peculiarity analyzation computer program is stored, a memory 128, a network interface 124 through which data is transmitted to and received from an external device, and a system bus 120 which is connected to the storage 122, the network interface 124, the processor 126, and the memory 128 to serve as a data movement path. The storage 122 is an auxiliary storage device such as a nonvolatile memory, a magnetic disk, or a hard disk.

According to one embodiment, an execution file and a resource file of the computer program 1280 to perform a step of receiving checkup data of an examinee having a first disease, a step of determining whether the checkup data coincides with a first disease statistic model obtained from a checkup value of a patient with the first disease, and a step of, when the checkup data does not coincide with the first disease statistic model as a result of the determination result, calculating a peculiar value of the examinee using only a part of the checkup values which coincide with the first disease statistic model among the checkup data may be stored in the storage 122.

According to another embodiment, an execution file and a resource file of the computer program 1280 to perform a step of receiving checkup data of an examinee having a first disease, a step of determining whether the checkup data coincides with a first disease statistic model obtained from the checkup value of a patient with the first disease, and a step of, when the checkup data does not coincide with the first disease statistic model as a result of the determination result, calculating a peculiar value α of the examinee may be stored in the storage 122.

At least a part of the operations contained in the computer program 1280 may be loaded on the memory 128, and the loaded operations is provided to the processor 126, and the processor executes the operations provided from the memory 128.

If checkup data of an examinee having the first disease is received from a remote apparatus via the network interface 124, the checkup data is loaded to the memory 128 temporarily. The processor 126 determines whether the checkup data coincides with a first disease statistic model obtained from a checkup value of a patient with the first disease, and when the checkup data does not coincide with the first disease statistic model as a result of the determination result, calculates a peculiar value of the examinee. The processor 126 may request the first disease statistic model via the network interface 124 to a remote apparatus which services a population DB, or request checkup data of patients having the first disease stored in the population DB to the remote apparatus.

Processor 126 may calculate the peculiar value of the examinee using only a part of the checkup values which coincide with the first disease statistic model among the checkup data may be stored in the storage 122.

Processor 126 may calculate the peculiar value of the examinee is so that values obtained by adding adjusted checkup values for each onset factor of the first disease is equal to a reference value of a patient and the adjusted checkup value for a specific onset factor is a value obtained by reflecting a personalized weight for the specific onset factor to the checkup value of the examinee for the specific onset factor.

When personalized weight for the specific onset factor is set to be a first weight designated using a peculiar value α of the examinee when the checkup value of the examinee for the specific onset factor coincides with the first disease statistic model for the specific onset factor and set to be a second weight designated using a peculiar value α of the examinee when the checkup value of the examinee for the specific onset factor does not coincide with the first disease statistic model for the specific onset factor. The first weight may be different from the second weight.

Processor 126 may transmit the calculated peculiar value of the examinee to a remote apparatus via the network interface 124.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method of analyzing checkup data of a target object using an apparatus including at least one processor, the method comprising:
receiving, by using the at least one processor, checkup data of a target object associated with a first disease, the checkup data comprising checkup values for a plurality of onset factors of the first disease;
determining, by using the at least one processor, whether the checkup data corresponds to a first disease statistic model obtained from checkup values of a plurality of objects associated with the first disease; and
calculating, by using the at least one processor, a peculiarity value of the target object when the checkup data is determined not to correspond to the first disease statistic model as a result of the determination,
wherein the peculiarity value of the target object is calculated such that a sum of adjusted checkup values, the adjusted checkup values being obtained by adjusting checkup values for respective onset factors of the first disease of the target object based on the peculiarity value, is equal to a reference value.

2. The method of claim 1, wherein the reference value is obtained by using the following equation:
Σᵢ₌₁^{M}(DF_MIDᵢ*DCRᵢ)=T,
wherein T represents the reference value, DF_MIDᵢ represents a checkup value median for an i-th onset factor in accordance with the first statistic disease model, DCRᵢ represents an onset contribution ratio of the i-th onset factor, and M represents a number of the plurality of onset factors, the onset contribution ratio indicating a ratio of an onset factor in contributing to an onset of the first disease,
the checkup value median DF_MIDᵢ indicates a distance between a center of a representative cluster of points indicating the checkup values of the plurality of objects for each onset factor, the points being mapped to an n dimensional space, and an origin of the n dimensional space, n being a number of a plurality of sub onset factors of the each onset factor.

3. The method of claim 1, wherein the reference value is obtained by using the following equation:
Σᵢ₌₁^{M}(DF_MIDᵢ*DCRᵢ)=T,
wherein T represents the reference value, DF_MIDᵢ represents a checkup value median for an i-th onset factor in accordance with the first statistic disease model, DCRᵢ represents an onset contribution ratio DCRᵢ of the i-th onset factor, and M represents a number of the plurality of onset factors, the onset contribution ratio indicating a ratio of an onset factor in contributing to an onset of the first disease,
the checkup value median DF_MIDᵢ indicates an average value of distances between points included in a representative cluster of points indicating the checkup values of the plurality of objects for each onset factor, the points being mapped to an n dimensional space, and an origin of the n dimensional space, n being a number of a plurality of sub onset factors of the each onset factor.

4. The method of claim 1, wherein the determining comprises:
generating the first disease statistic model using checkup values for the plurality of onset factors of the first disease of the plurality of objects associated with the first disease, the checkup values of the plurality of objects being stored in a database, and
the checkup values of the plurality of objects comprise checkup values for a plurality of sub onset factors of the each onset factor of the plurality of objects.

5. The method of claim 4, wherein the generating the first disease statistic model comprises:
mapping a point indicating a checkup value for a first onset factor of the first disease of each object of the plurality of objects to an n dimensional space (n being a number of a plurality of sub onset factors of the first onset factor), the checkup value comprising checkup values for the plurality of sub onset factors of the first onset factor of the first disease;
obtaining a representative cluster for the first onset factor, based on a density of mapped points clustered in the n dimensional space;
setting the representative cluster as a first disease statistic model for the first onset factor, and
performing the mapping, the obtaining, and the setting with respect to a second to an M-th onset factors (M being a number of the plurality of onset factors of the first disease) of the first disease.

6. The method of claim 5, wherein the obtaining comprises:
selecting a point among the mapped points in the n dimensional space;
determining, as the representative cluster, a cluster having the selected point as a center when a predetermined number of points are present within a predetermined radius from the selected point;
adjusting, when no cluster is determined as the representative cluster, at least one of the predetermined radius and the predetermined number.

7. The method of claim 6, further comprising:
selecting another point among the mapped points in the n dimensional space; and
determining another cluster as the representative cluster.

8. The method of claim 5, wherein the determining whether the checkup data corresponds to the first disease statistic model further comprises:
mapping a checkup value for the first onset factor of the target object to the n dimensional space;
determining whether the checkup value for the first onset factor of the target object corresponds to the first disease statistic model based on whether the mapped checkup value for the first onset factor of the target object is included in the representative cluster for the first onset factor; and
performing the mapping the checkup value of the target object and the determining whether the checkup value for the first onset factor of the target object corresponds to the first disease statistic model with respect to the second to the M-th onset factors.

9. The method of claim 8, wherein the determining whether the checkup value for the first onset factor of the target object corresponds to the first disease statistic model comprises:
assigning, when the mapped checkup value for the first onset factor of the target object is included in the representative cluster for the first onset factor, a point value, to which an onset contribution ratio of the first onset factor is applied, to the first onset factor, the onset contribution ratio indicating a ratio of an onset factor in contributing to an onset of the first disease;
repeating the assigning for the second to the M-th onset factors; and
determining, when a value obtained by adding the assigned point values for the first to the M-th onset factors exceeds a threshold value, that the checkup data of the target object corresponds to the first disease statistic model.

10. The method of claim 8, wherein the determining whether the checkup value for the first onset factor of the target object corresponds to the first disease statistic model comprises:
calculating a distance between the mapped checkup point for the first onset factor of the target object and a center of the representative cluster for the first onset factor;
adjusting the calculated distance by applying a weight determined based on an onset contribution ratio of the first onset factor, the onset contribution ratio indicating a ratio of an onset factor in contributing to an onset of the first disease;
repeating the calculating the distance and adjusting the calculated distance with respect to the second to the M-th onset factors; and
determining, when a value obtained by adding the adjusted distances for the first to the M-th onset factors is below a threshold value, that the checkup data of the target object corresponds to the first disease statistic model.

11. The method of claim 1, wherein the first disease statistic model is obtained from checkup values for the plurality of onset factors of the first disease of the plurality of objects associated with the first disease, the checkup values of the plurality of objects being stored in a database, and
the method further comprises:
updating the database by adding checkup data of a first object to the database;
generating an updated first disease statistic model using the updated database; receiving checkup data of a second object associated with the first disease; and
determining whether the checkup data of the second object corresponds to the updated first disease statistic model.

12. The method of claim 1, further comprising:
determining whether the checkup data corresponds to a second disease statistic model obtained from checkup values of a plurality of objects associated with the second disease, when the target object is associated with the second disease which is different from the first disease; and
calculating, when it is determined that the checkup data does not correspond to the second disease statistic model, an updated peculiarity value of the target object, using at least one checkup value which corresponds to the second disease statistic model among the checkup data of the target object.

13. The method of claim 1, further comprising:
predicting an onset possibility of the target object for a second disease which is different from the first disease, using the calculated peculiarity value.

14. The method of claim 13, wherein the predicting comprises:
adjusting at least a portion of the checkup values by applying the peculiarity value to the at least a portion of the checkup values as a weight;
determining whether checkup data of the target object including the adjusted checkup values corresponds to a second disease statistic model obtained from checkup values of a plurality of objects associated with the second disease; and
predicting the onset possibility of the target object for the second disease based on a result of the determination.

15. The method of claim 1, further comprising:
transmitting the calculated peculiarity value to an apparatus for adjusting of a prescription of the target object using the peculiarity value.

16. A method of analyzing checkup data of a target object using an apparatus including at least one processor, the method comprising:
receiving, by using the at least one processor, checkup data of a target object associated with a first disease, the checkup data comprising checkup values for a plurality of onset factors of the first disease;
determining, by using the at least one processor, whether the checkup data corresponds to a first disease statistic model obtained from checkup values of a plurality of objects associated with the first disease; and
calculating, by using the at least one processor, a peculiarity value of the target object when it is determined that the checkup data does not correspond to the first disease statistic model,
wherein the peculiarity value of the target object is calculated such that a sum of adjusted checkup values, the adjusted checkup values being obtained by adjusting checkup values for respective onset factors of the first disease of the target object based on the peculiarity value, is equal to a reference value,
a checkup value of the target object for a specific onset factor is adjusted by applying a first weight based on the peculiarity value when the checkup value of the target object for the specific onset factor corresponds to the first disease statistic model for the specific onset factor, and by applying a second weight based on the peculiarity value when the checkup value of the target object for the specific onset factor does not correspond to the first disease statistic model for the specific onset factor, and
the first weight is different from the second weight.

17. The method of claim 16, wherein the first weight has a positive (+) value but the second weight has a negative (−) value.

18. The method of claim 16, wherein the first weight and the second weight are positive (+) values and the first weight is larger than the second weight.

19. A method of analyzing checkup data of a target object using an apparatus including at least one processor, comprising:
receiving, by using the at least one processor, checkup data of a target object associated with a first disease, the checkup data comprising checkup values for a plurality of onset factors of the first disease;
determining, by using the at least one processor, whether the checkup data corresponds to a first disease statistic model obtained from checkup values of a plurality of objects associated with the first disease; and
calculating, by using the at least one processor, a peculiarity value of the target object using at least one checkup value of the target object, the at least one checkup value corresponding to the first disease statistic model, among the checkup data, when the checkup data does not correspond to the first disease statistic model.

20. The method of claim 19, wherein the calculating the peculiarity value, comprises:
calculating the peculiarity value of the target object such that a sum of adjusted checkup values, the adjusted checkup values being obtained by adjusting, based on the peculiarity value, the at least one checkup value corresponding to the first disease statistic model for a respective onset factor, is equal to a reference value.

21. The method of claim 20, wherein the adjusted checkup values are obtained by applying an onset contribution ratio for the respective onset factor of the at least one checkup value as a first weight, and applying the peculiarity value as a second weight, the onset contribution ratio indicating a ratio of an onset factor in contributing to an onset of the first disease.

22. The method of claim 21, wherein the reference value is obtained by using the following equation:
Σᵢ₌₁^{M}(DF_MIDᵢ*DCRᵢ)=T,
wherein T represents the reference value, DF_MIDᵢ represents a checkup value median for an i-th onset factor in accordance with the first statistic disease model, DCRᵢ represents an onset contribution ratio of the i-th onset factor, and M represents a number of the plurality of onset factors, the onset contribution ratio indicating a ratio of an onset factor in contributing to an onset of the first disease.

23. A computer program product embodied on a non-transitory readable storage medium containing instructions that, when executed by a computer, cause the computer to:
receive checkup data of a target object associated with a first disease, the checkup data comprising checkup values for a plurality of onset factors of the first disease;
determine whether the checkup data corresponds to a first disease statistic model obtained from checkup values of a plurality of objects associated with the first disease; and
calculate a peculiarity value of the target object when the checkup data is determined not to correspond to the first disease statistic model as a result of the determination,
wherein the peculiarity value of the target object is calculated such that a sum of adjusted checkup values, the adjusted checkup values being obtained by adjusting checkup values for respective onset factors of the first disease of the object based on the peculiarity value, is equal to a reference value.

24. An apparatus for analyzing checkup data of an object, the apparatus comprising:
a processor;
a memory; and
a storage device in which an execution file of a computer program which is loaded to the memory and executed by the processor is recorded,
wherein the computer program comprises:
code that causes the processor to receive checkup data of a target object associated with a first disease, the checkup data comprising checkup values for a plurality of onset factors of the first disease;
code that causes the processor to determine whether the checkup data corresponds to a first disease statistic model obtained from checkup values of a plurality of objects associated with the first disease; and
code that causes the processor to calculate a peculiarity value of the target object when the checkup data is determined not to correspond to the first disease statistic model as a result of the determination,
wherein the peculiarity value of the target object is calculated such that a sum of adjusted checkup values, the adjusted checkup values being obtained by adjusting checkup values for respective onset factors of the first disease of the object based on the peculiarity value, is equal to a reference value.
